(19) United States
(12) Patent Application Publication
(10) Pub. No.: US 2002/0062905 A1
(43) Pub. Date: May 30, 2002

(54) Process for bonding of stitched carpets

(76) Inventor: Dimitri P. Zafiroglu, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/727,207

(22) Filed: Nov. 30, 2000

(51) Int. Cl. B32B 7/08

(52) U.S. Cl. 156/93; 156/161

(57) ABSTRACT

A thermoplastic binder applied in the vicinity of the roots of a pile surface structure, typically before stitching, is raised above its melting point but below the critical exposure temperature that can adversely affect the properties of the material forming the pile elements. While at this elevated temperature the pile surface structure is mechanically flexed, as by repeatedly bending the backing with the pile loops thereon into and out of its plane. This flexing action assists the molten (but not freely flowing) binder to propagate into the roots of the pile elements and into the interstices between the fibers forming the same.

### BACKGROUND OF THE INVENTION

1. Field of the Invention

The present invention relates to a method for bonding of stitched carpets.

2. Description of the Prior Art

Published application WO 00/52246, the PCT counterpart of co-pending application U.S. application Ser. No. 09/260,749, filed Mar. 2, 1999 and assigned to the assignee of the present invention, discloses a stitched pile surface structure having a thermoplastic binder disposed in the vicinity of the roots of the pile elements. To be most effective the binder material should penetrate into the roots of the pile elements and into the interstices between the filaments forming the same.

Disposing the binder material in these locations requires some care, as the operating temperature window for binder processing is, in most cases, relatively narrow. On one hand the binder must have a melting temperature that is sufficiently high so that the binder remains set when exposed to the expected maximum end-use temperatures for a pile surface structure, typically in the vicinity of eighty degrees Centigrade (80° C.). On the other hand, processing the binder at too high a temperature may negatively affect the material from which the pile elements are made. For example, in the case of nylon pile elements, temperatures in excess of approximately one hundred twenty degrees Centigrade (120° C.) may adversely affect certain properties of the nylon material forming the pile elements.

Accordingly, it is not simply a matter of raising the temperature of the binder to an extent that the binder freely flows into the desired locations in the pile surface structure.

In view of the narrow temperature operating window it is imperative that physical pressure be exerted while the thermoplastic binder is molten but not freely flowing, to help the binder propagate into the desired bond areas.

It should be noted that care must also be exercised when applying pressure to the pile surface structure. Applying nip pressure, by pressing from above and below with pressure rolls, is a mechanical expedient occasionally used in the industry to apply pressure to a pile structure. However, nip pressure may have the undesirable side effect of “matting”, or “crushing”, the pile.

Accordingly, in view of the foregoing it is believed desirable to provide a process, which utilizes a binder material with a relatively low melting point so that the binder can be processed at a temperatures under the critical temperatures that adversely affect the pile material. The process should, at the same time, be practiced in a physical environment in which pressure may be brought to bear on the pile to cause the thermoplastic binder to propagate without crushing of the pile. It is believed to be of further advantage to achieve this result while the pile surface structure is subjected to usual industry finishing processes, such as scouring, dyeing and drying.

### SUMMARY OF THE INVENTION

In accordance with the present invention a thermoplastic binder is applied in the vicinity of the roots of a pile surface structure, typically before stitching. The binder material is raised above its melting point but below the critical exposure temperature that can adversely affect the properties of the material forming the pile elements. While at this elevated temperature the pile surface structure is mechanically flexed, as by repeatedly bending the backing with the pile loops thereon into and out of its plane. This flexing action assists the molten (but not freely flowing) binder to propagate into the roots of the pile elements and into the interstices between the fibers forming the same. In the preferred implementation the process is practiced using conventional dyeing systems wherein the temperature is customarily raised and flexing customarily employed to promote dye propagation and dye setting. The process may also be practiced in equipment, which flexes the heated pile structure over small-diameter rolls or bars.

Optionally, the pile structure may be scoured before the flexing step, and/or, subjected to a final heating step without flexing.

### BRIEF DESCRIPTION OF THE DRAWINGS

The invention will be more fully understood from the following detailed description, taken in connection with the accompanying drawings which form a part of this application, and in which:

FIG. 1 is stylized view of a finished pile surface structure manufactured in accordance with the process of the present invention;

FIGS. 2A through 2E are stylized block diagrammatic views illustrating various embodiments of the process of the present invention;

FIGS. 3A through 3H are stylized views illustrating the unfinished pile surface structure at reference point R along the process wherein each unfinished pile surface structure has a thermoplastic binder present in the vicinity of the root portions thereof;

FIGS. 4 and 5 are stylized diagrammatic views illustrating apparatus for mechanically flexing the pile surface structure into and out of the plane of the backing at a temperature greater than the melting point of the binder.

### DETAILED DESCRIPTION OF THE INVENTION

Throughout the following detailed description similar reference numerals refer to similar elements in all figures of the drawings.

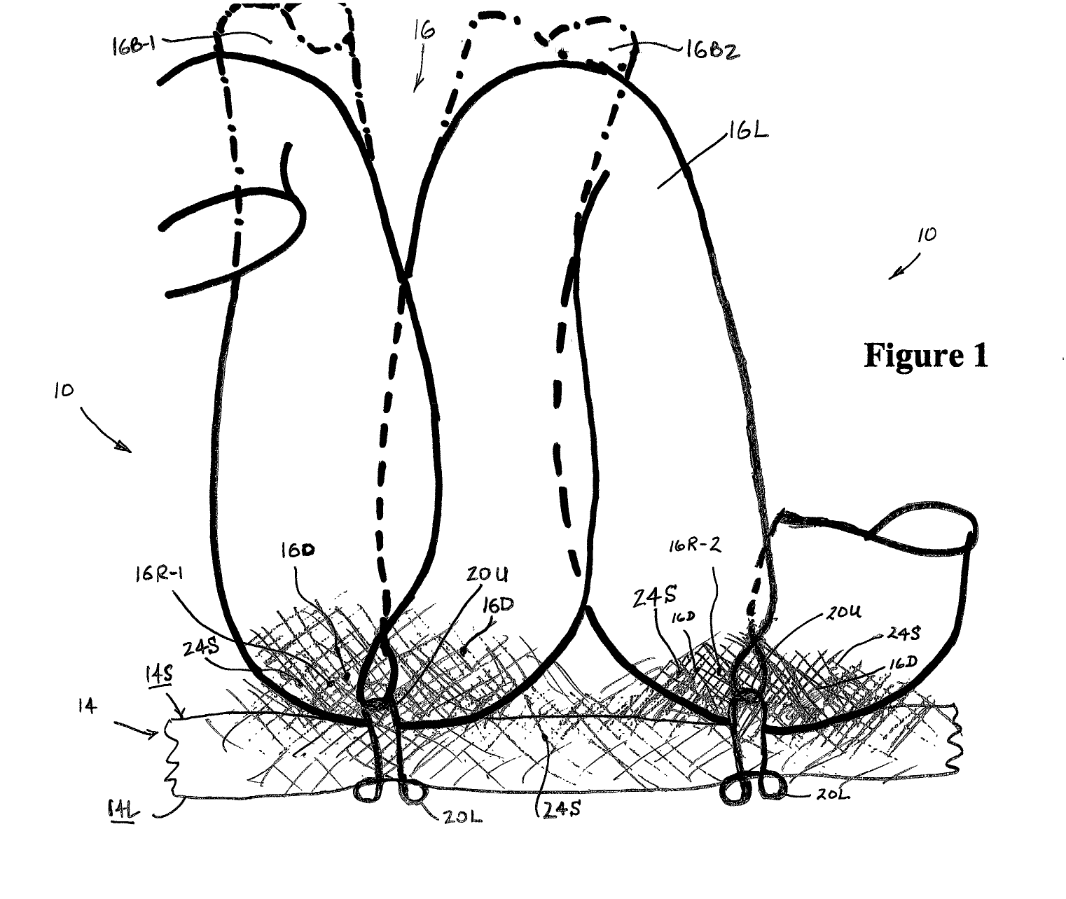

With reference to FIG. 1 shown is a stylized diagrammatic view of a portion of a finished, stitched pile surface structure generally indicated by the reference character 10 manufactured in accordance with the process of the present invention.

The pile surface structure 10 includes a backing 14 having an upper surface 14S and a lower surface 14L thereon. An array of pile yarn elements 16 is stitched to the upper surface 14S of the backing 14.

The pile yarn elements 16 are formed using a stitching apparatus of the type having a sinker bar carrying an array of sinker fingers. Details of a suitable stitching apparatus are set forth in published application WO 00/52246, the PCT counterpart of co-pending application U.S. application Ser. No. 09/260,749, filed Mar. 2, 1999 and assigned to the assignee of the present invention.

Briefly summarized, the stitching apparatus used to form the pile surface structure includes a transversely extending sinker bar from which extends a plurality of sinker fingers. The sinker fingers project forwardly past a needle plane defined by the reciprocating operation of an array of stitching needles. The backing 14 is conveyed through the stitching apparatus so that successive transversely extending regions of the backing 14 are advanced into the needle plane. Stitching threads from adjacent thread-carrying guide bars are successively looped around respective spaced locations on a length of yarn dispensed from a yarn guide bar.

As successive transverse regions of the backing 14 move into the needle plane pairs of adjacent first and second needles are actuated and raised through the backing to positions above the sinker fingers. In the raised positions the adjacent needles respectively successively engage the looped stitching threads and draw these stitching threads toward the backing 14. These actions draw the length of dispensed yarn to the surface 14S of the backing 14.

As the adjacent needles draw the threads downwardly toward the backing 14 the dispensed length of yarn becomes trained over the surface of the sinker finger, thereby forming a laid-in pile yarn element 16 overlying above the first surface 14S of the backing 14. Continued downward movement of each needle through the backing 14 forms an underlap portion 20U of a chain stitch 20. The underlap 20U of the stitch 20 secures the pile yarn element 16 against the first surface 14S. Each stitch 20 also includes an interlockable looped overlap portion 20L that lies against the bottom surface 14B of the backing 14. Sequential overlap portions 20L typically interlock with each other, chain-fashion, longitudinally along the bottom surface 14B of the pile surface structure 10.

In a loop pile embodiment illustrated in FIG. 1 the pile element 16 has the form of an inverted loop 16L that overlies the top surface 14S of the backing between a first generally U-shaped root portion 16R-1 located in a first longitudinally extending stitch line and a second generally U-shaped root portion 16R-2 located in a second longitudinally extending stitch line. The root portions 16R-1, 16R-2 are each held against the top surface 14S of the backing 14 by the underlap portion 20U of one of the stitches 20. The underlaps 20U constrict the pile yarn to form distended regions 16D in the vicinity of each underlap 20U.

As is illustrated by the dot-dash lines in FIG. 1 the pile element 16 may also be implemented in a cut pile form. The cut pile is produced by cutting the loop 16L of the pile element near the apex of the loop, resulting in the formation of a pair of cut pile elements. Each cut pile element has one generally U-shaped root portion, e.g. root 16R-1, in the vicinity of each underlap 20U of the stitching thread. Two substantially erect branches 16B-1, 16B-2 extend from the U-shaped root portion 16R-1. Expressed alternatively, a loop pile yarn element may be-considered as the pile structure defined by the integral jointure of one branch of a cut pile element lying in a first stitch line to a branch emanating from a cut pile element disposed in an adjacent stitch line.

A binder material assists in securing the pile element 16 to the upper surface 14S of the backing 14. In FIG. 1 the binder material in its final solidified condition is illustrated by the hatched shading 24S. As seen from FIG. 1 the major portion of the final solidified binder material 24S is concentrated above the backing 14 in the vicinity of the U-shaped root portions of the pile elements 16, primarily surrounding the underlaps 20U holding the pile element 16 to the top surface 14S of the backing 14.

More particularly, the final solidified binder material 24S is concentrated:

(a) in the distended regions 16D of the pile element formed by the constricting underlaps 20U:

(b) in the constricted portion of the roots 16R-1, 16R-2 near the underlaps 20U;

(c) in the thread forming the underlaps 20U;

(d) in the space between distended regions 16D;

(e) in the space between distended regions 16D and the first surface 14S of the backing 14; and

(f) near the upper surface 14S of the backing 14 adjacent to the roots 16R-1, 16R-2 of the pile elements 16.

It is noted that some final solidified binder material 24S may be incidentally present in regions of the backing spaced from the roots.

Substantially all of the filaments of the pile yarn and the interstices therebetween in the distended regions 16D of the root portions of substantially all of the pile elements 16 have set binder material 24S present thereon. At least the upper two-thirds of each pile yarn element 16 remains substantially free of binder material.

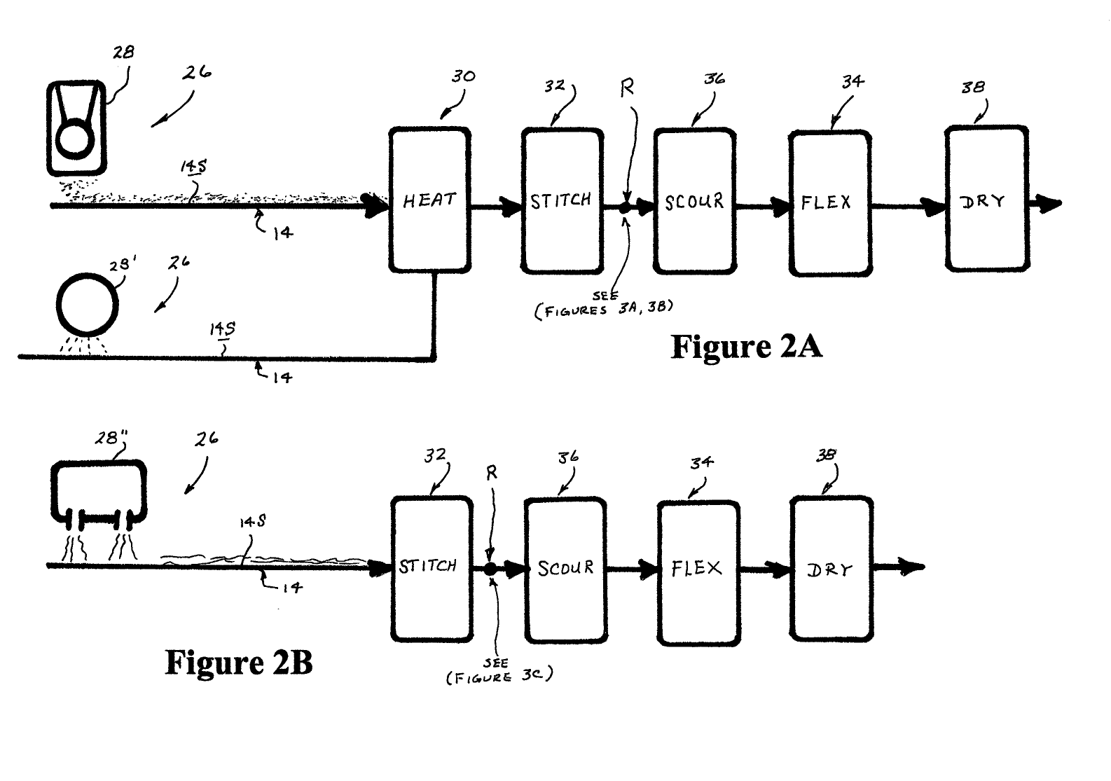

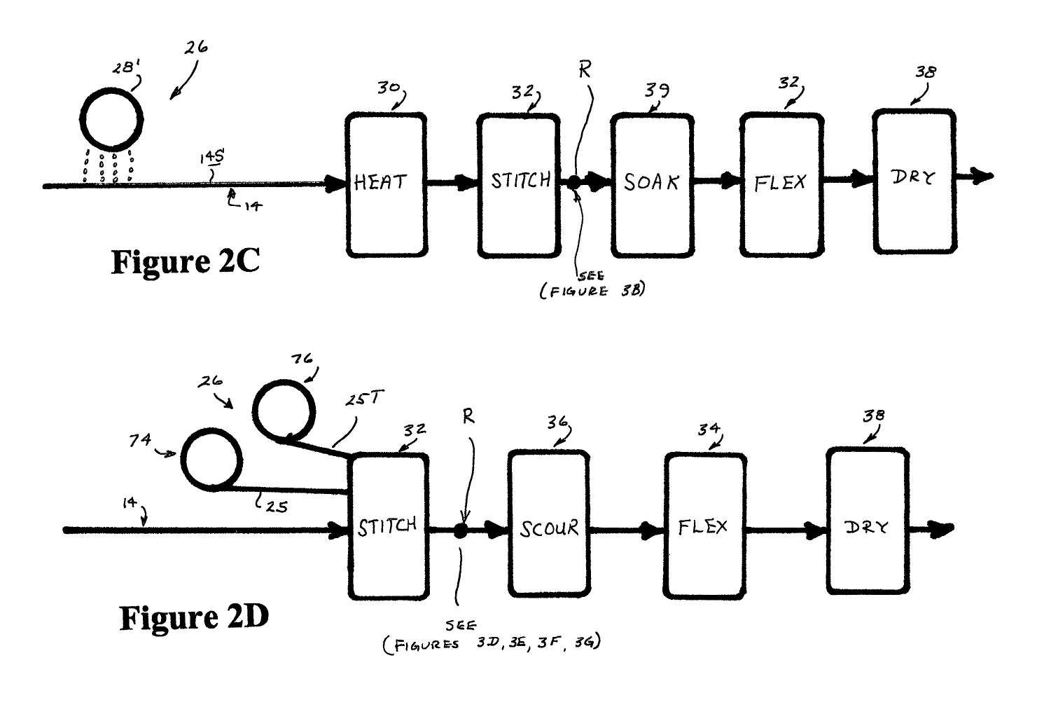

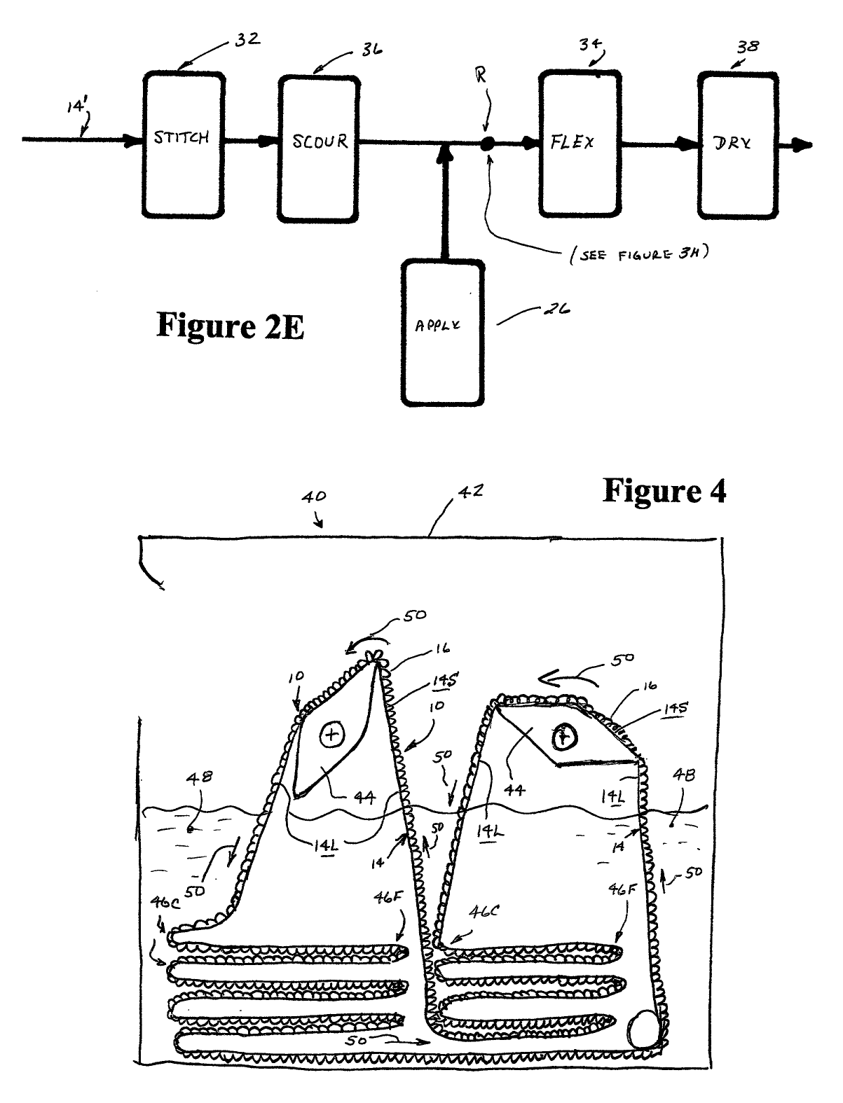

FIGS. 2A through 2E are stylized block diagrammatic views illustrating various embodiments of the process of the present invention.

The initial step in accordance with the present invention is the application of a thermoplastic binder material having a predetermined melting point in the vicinity of the root portion of the loops. This binder application is generally indicated throughout these FIGS. 2A-2E by the reference character 26. The particular mode of application depends upon the particular physical form taken by the binder material.

Whatever its physical form, in the preferred instance the binder material is an amorphous binder. Typically, the melting point of the amorphous thermoplastic binder lies in the range from about eighty-five to about one hundred degrees Centigrade (85-100° C.). An amorphous thermoplastic binder tends to flow more readily than a thermoplastic binder in the form of film or strands.

As will be developed the amorphous thermoplastic binder is most preferably in the physical form of a powder having particles with sizes in the range from about one (1) to about five hundred (500) microns. A suitable amorphous thermoplastic binder material useful for the purpose here described is that available from EMS Corporation, Ems Switzerland, as Griltex 1500A P-1 powder.

The most preferred technique of binder application is to apply an amorphous binder material to the surface 14S of the backing 14 in the form of a dry powder. The binder powder is scattered from a dispenser 28 onto the upper surface 14S of the advancing backing 14. Suitable for use as the dispenser is a scattering device manufactured and sold by the Herbert Meyer Company, Roetz, Germany.

It lies within the contemplation of the present invention to mix with the binder powder a small percentage of a secondary thermoplastic adhesive powder. Preferably the secondary thermoplastic adhesive powder also has particle sizes in the range from about one (1) to about five hundred (500) microns and a melting point in the range from about five (5) to about twenty (20) degrees Centigrade ° C. below the melting point of the primary binder powder. The secondary thermoplastic adhesive powder is on the order from about five percent (5%) to about twenty percent (20%) of the weight of the primary binder. A suitable thermoplastic material useful for the secondary thermoplastic adhesive powder is that available from EMS Corporation, Ems Switzerland, as Griltex 1531A.

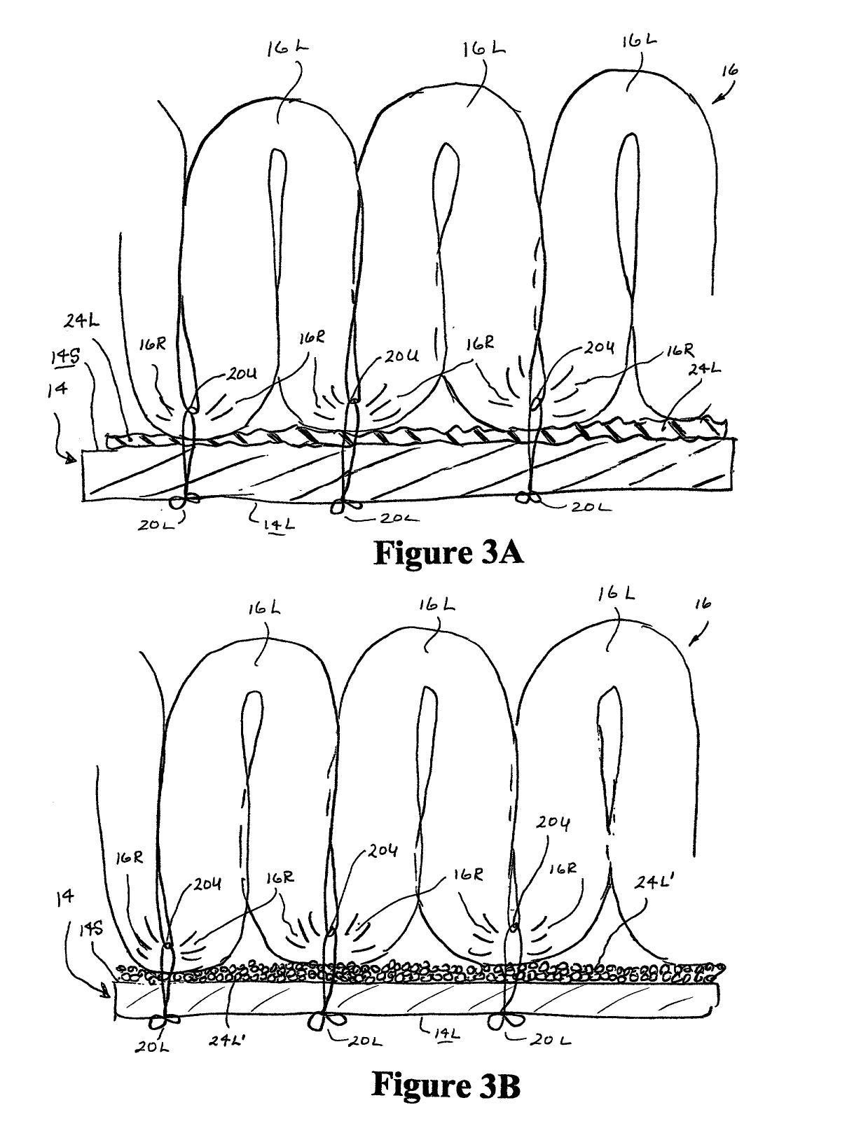

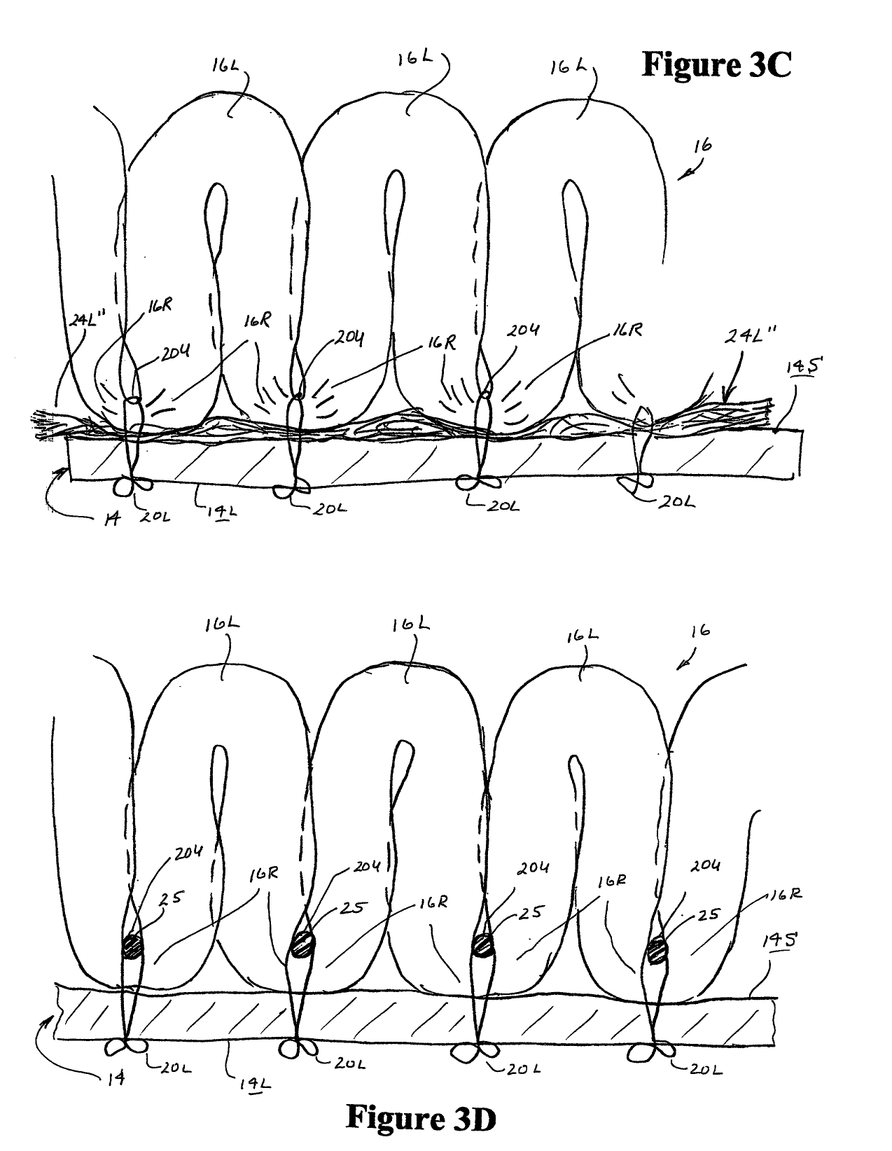

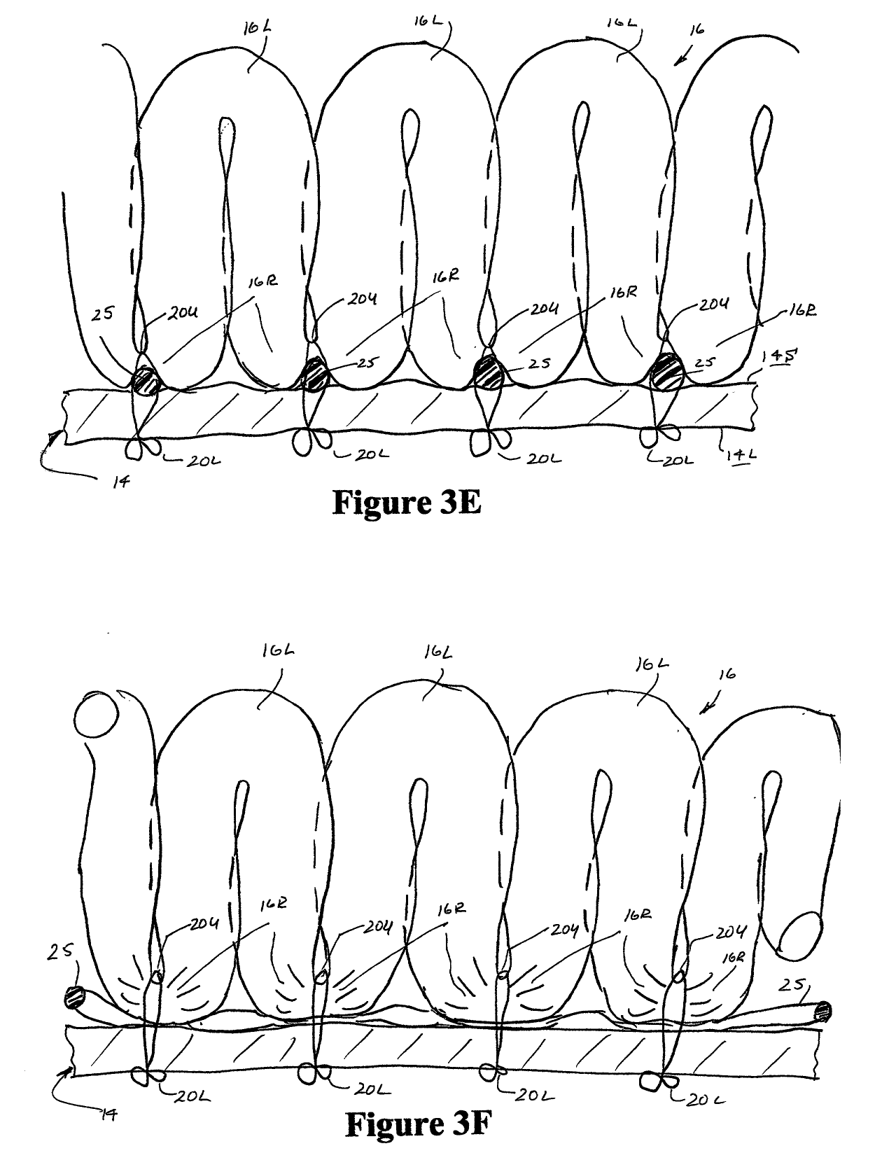

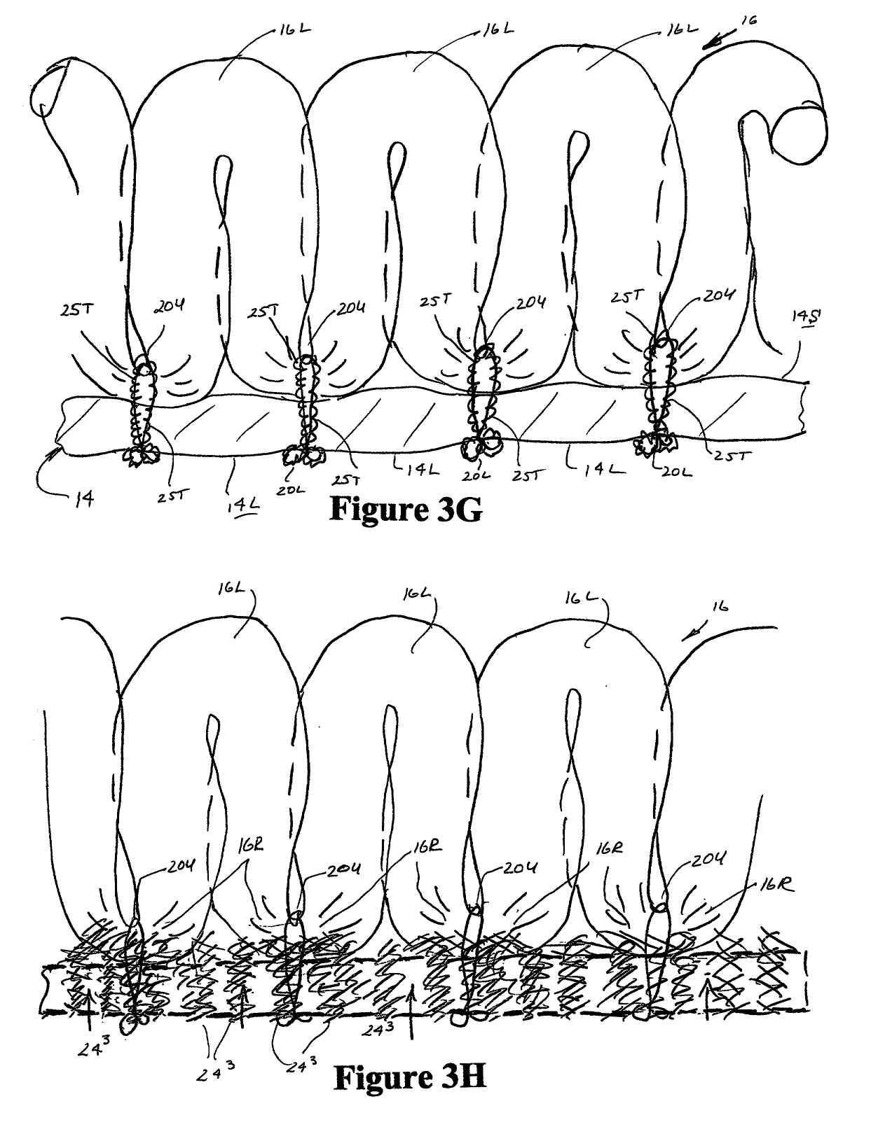

After the primary binder powder (or the mixture of the primary binder powder and the secondary thermoplastic adhesive powder) is applied the backing is heated to a predetermined temperature. This heating step is generally indicated by the reference character 30. Any suitable heating device may be used to implement the heating step, such as an oven, a radiant heater or a hot gas heater. The predetermined temperature to which the backing 14 is heated is dependent upon whether the binder powder alone or the powder mixture is applied to the surface 14S. If only a primary binder powder is applied to the surface 14S, the backing 14 is heated to a temperature slightly (on the order if a few degrees) greater than the melting point of the primary binder powder, thus melting the primary powder binder and attaching the same to the backing 14. After solidifying downstream of the heating device a layer of the primary powder binder (indicated by the reference character 24L in FIG. 3A) is attached over the surface 14S of the backing 14.

If a mixture of a primary binder powder and a secondary thermoplastic adhesive powder is applied to the surface 14S, the backing 14 is heated to a temperature slightly greater than the melting point of the secondary thermoplastic adhesive powder but less than the melting point of the primary binder. Heating to this temperature melts the secondary thermoplastic adhesive powder. When solidified after leaving the heating device a layer of the primary powder binder supported in an adhesive matrix (indicated by the reference character 24L′ in FIG. 3B) is attached over the surface 14S of the backing 14.

The backing 14 with the binder material 24L, 24L′ applied to the surface 14S thereof is next stitched, as indicated by the reference character 32, using a stitching apparatus such as the one described above. In the stitching apparatus the pile elements 16 are formed on the backing 14 in the manner above discussed. Accordingly, as illustrated in FIGS. 3A or 3B, at the reference point R at the outlet of the stitching apparatus the upper surface 14S of the backing 14 has an array of pile elements 16 formed thereover. The root portions 16R of the pile elements 16 are attached to the backing 14 by the underlaps 20U of the stitches 20. The surface 14S of the backing has a layer 24L, 24L′, as the case may be, of binder disposed thereon.

In accordance with the present invention, after formation, the pile surface structure 10 is mechanically flexed into and out of the plane of its backing 14 at a temperature greater than the melting point of the binder. This mechanical flexing at the elevated temperature is indicated by the reference character 34. The term “mechanically flexing” (or a similar term) of the pile surface structure 10 into and out of the plane of its backing 14 is meant to denote repeatedly folding and counter-folding the backing in such a way that portions of the pile surface and portions of the backing are alternatively brought toward and away from each other.

The elevated temperature causes the binder material to melt. The flexing action imposes mechanical forces on the then-molten binder causing it to flow and to penetrate into the root portions of the pile loops in the vicinity of the stitching thread underlaps holding the same to the backing and into the interstices between the filaments forming the pile loops.

In one embodiment of the invention the temperature at which the flexing occurs is maintained by immersing the pile surface structure 10 in a liquid having a temperature greater than the melting point of the binder. An example of a suitable apparatus 40 in which the immersion and flexing occurs is illustrated in diagrammatic form in FIG. 4. The apparatus 40, generally similar to a standard Beck dye bath apparatus, includes an enclosure 42 having a pair of agitating rotors 44 rotationally mounted therein. The rotors 44 may be any suitable configuration to effect the action to be described. In FIG. 4 the rotors 44 are each substantially diamond-shaped in cross section.

In operation, a length of pile surface structure 10 is formed into an endless loop that is trained over the rotors 44. Preferably, the lower surface 14L of the backing 14 engages against the rotors 44 to avoid crushing of the pile elements 16 on the upper surface 14S of the backing. Portions of the pile surface structure 10 are folded and counter-folded upon themselves both upstream and downstream of each rotor. Some folding of the pile surface structure, such as that indicated by the reference character 46F, causes the pile elements on portions of the pile surface structure 10 to be brought toward each other while portions of the backing are simultaneously brought away from each other. Alternatively, counter-folding, such as that indicated by the reference character 46C, brings portions of the backing toward each other while pile elements on the opposite surface of the backing are brought away from each other.

The folded and counter-folded portions of the pile structure are submerged in the liquid 48 disposed in the lower portion of the enclosure 42. The liquid 48 is maintained at the desired temperature sufficient to melt the binder material. As the rotors 44 rotate in the directions indicated by the reference arrows 50, the pile surface structure 10 is drawn from the liquid bath 48 and is continuously flexed as the backing 14 of the pile structure 10 folds and unfolds into and out of the liquid bath 48. Each progressive reversal of direction in the backing 14, both within the bath 48 as well as over the rotors 44, flexes the backing 14 into and out of its plane. This mechanical flexing action creates pressure in the pile elements 16 and causes the then-molten binder to flow into the root portion of the pile loops and into the interstices of filaments forming the pile elements. The pile surface structure 10 is subjected to the treatment described for a suitable period of time, e.g., in the range from about several minutes to several hours.

As may be appreciated, a standard Beck dye chamber may be used to effect suitable mechanical flexing action in the elevated temperature liquid.

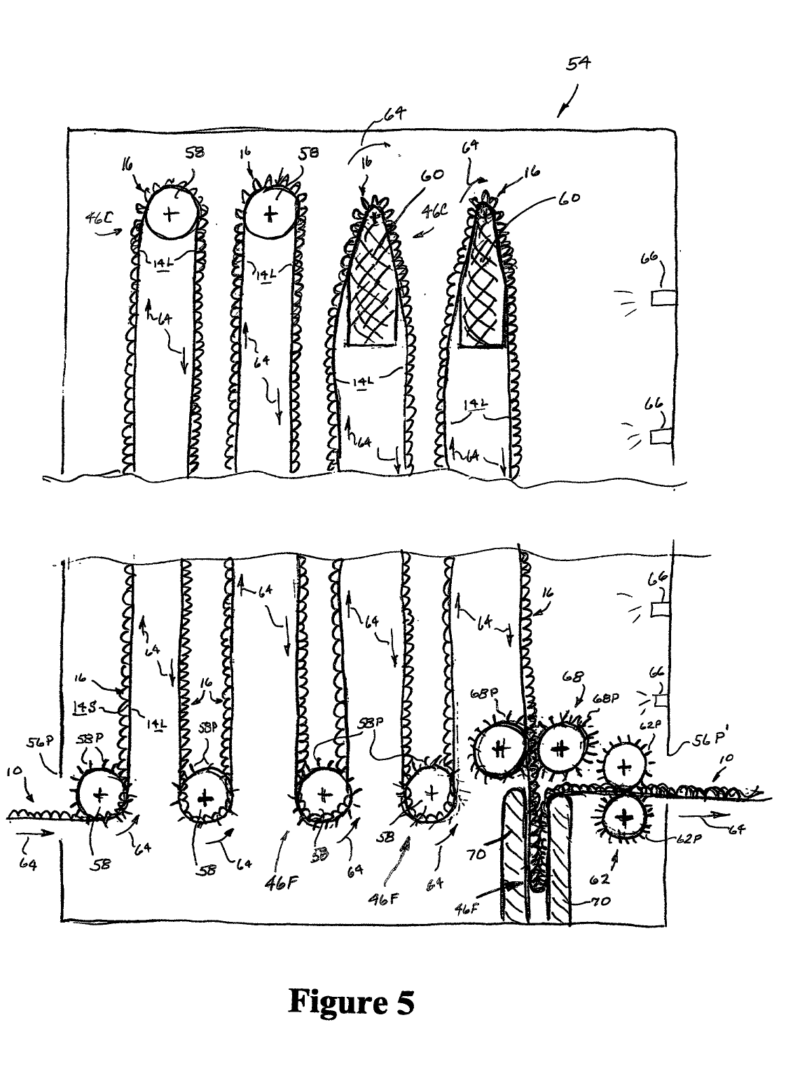

In another embodiment of the invention the temperature at which the flexing occurs is maintained by passing steam or a heated gas having a temperature greater than the melting point of the binder over the pile surface structure 10. An example of a suitable apparatus 54 for this purpose is illustrated in stylized diagrammatic form in FIG. 5. The apparatus 54, generally similar to a standard vertical steamer apparatus, includes an enclosure 56 having entrance port 56P and exit port 56P′ defined in the walls thereof. Roller elements 58 and/or fixed abutments 60 (if desired) are mounted within the enclosure 56. The rollers 58 and the abutments 60 may be any suitable configuration to effect the action to be described. For example, as suggested in FIG. 5, the rollers 58 (which may be implemented as rotatably mounted bars) may be circular while the abutments 60 may be pyramidal in cross section.

In operation, a length of pile surface structure 10 is threaded over the rollers 58 and the abutments 60. The pile surface structure 10 is drawn through the enclosure 56 by the action of a pair of nip rolls 62 disposed in a convenient location, such as adjacent to the exit port 56P′. Preferably, those rollers 58 which interface against the pile elements 16 (i.e., the lower rollers 58 in FIG. 5) have pins 58P which penetrate into the upper surface 14S of the backing 14, to avoid crushing of the pile elements 16. The other rollers engage the bottom surface 14B of the backing 14. The nip roll 62 may also be provided with pins 62P, if desired.

The pile surface structure 10 is drawn into and through the enclosure 56 by the action of the nip rolls 62, as indicated by the reference arrows 64. The pile surface structure 10 is thus conveyed, in serpentine fashion, over and under the rollers 58 and/or the abutments 60 mounted within the enclosure 56. At the same time the pile surface structure 10 within the enclosure 56 is subjected to a flow of steam or hot gas (such as hot air) introduced into the enclosure, as from suitable jets 66 provided for that purpose. The temperature of the steam or hot gas is sufficient to melt the binder material on the pile surface structure 10.

Each reversal of direction of the pile surface structure over or under the rollers 58 and/or the abutments 60 folds and counterfolds the backing 14 of the pile surface structure into and out of its plane (as again indicated by the reference characters 46F, 46C), similar to the mechanical flexing action discussed in connection with FIG. 4. This mechanical flexing action creates pressure in the pile elements 16 and causes the binder to flow into the root portion of the pile loops and into the interstices of filaments forming the pile elements. The rollers 58 and/or the rounded tip of the abutments 60 have a relatively small radius that increases the flexing of the backing and therefore the pressure exerted on the binder.

Yet further, a second pairs of nip rolls 68 (with pins 68P) may be mounted within the enclosure 56. These nip rolls 68 serve to force a length of the pile surface structure 10 into a U-shaped region defined between plates 70 and thus, further flexing the pile structure 10.

Prior to mechanically flexing the pile surface structure 10 may be scoured in a vat of heated liquid to remove substantially all oil and finish from the pile loops. This action is indicated diagrammatically in FIG. 2A by the reference character 36. The scouring may be effected by passing the pile surface structure 10 through using a heated liquid disposed within a suitable enclosure. The scouring liquid should preferably contain a detergent and, optionally, a surfactant. Of course, if the pile surface structure 10 is flexed using the heated liquid apparatus of FIG. 4, scouring may be performed simultaneously with the flexing, and a separate scouring step may not be required.

After the flexing action is completed, especially if the flexing is carried in the presence of the heated liquid or steam, the pile surface structure is dried, as indicated by step 38. Any suitable dryer apparatus may be used. A suitable time-temperature profile would dry the pile surface structure at a temperature of at least one hundred ten degrees Centigrade (110° C.) for at least two (2) minutes, to improve plastic flow and adhesion during drying.

The finished pile surface structure (FIG. 1) is collected from the outlet of the drying step 38 on a suitable take-up mechanism (not shown).

FIG. 2A also illustrates an alternative manner 26 in which the binder is applied to the surface 14S of the backing 14. In this alternative manner the primary binder powder is applied in the form of a slurry comprising the primary binder powder dispersed in a liquid vehicle. Water containing a surfactant forms a suitable liquid vehicle. The slurry may be applied by spraying using a suitable spray apparatus 28′. Alternatively, the slurry may be applied by padding onto the surface 14S of the backing 14.

In another alternative embodiment, as diagrammatically illustrated in FIG. 2B, the binder may be applied to the backing 14 in a melt-blown dry state using a melt-spinning device 28″. Melt-blown materials are also amorphous and flow well. Compressed gas attenuates spun filaments of a molten polymer into a web-like structure. Melt-blowing produces a layer 24L″ of amorphous binder material onto the surface 14S of the backing 14, as is illustrated by the diagrammatic view shown in FIG. 3C.

After application of the binder the backing 14 is conveyed directly (i.e., without heating) to be stitched, where the pile surface structure 10 is formed in the manner described. The remaining steps of the method may be implemented as described in connection with FIG. 2A.

FIG. 2C illustrates yet another alternative manner 26 in which the binder is applied to the surface 14S of the backing 14. In this embodiment the primary binder powder is again applied in the form of a slurry dispensed from a suitable spray apparatus 28′. The slurry comprises the primary binder powder dispersed in a liquid vehicle (e.g., water). However, the liquid vehicle has a soluble adhesive dissolved therein. The soluble adhesive has a setting point in the range from five (5) to twenty (20) degrees Centigrade ° C. below the melting point of the binder. A surfactant may be required in the liquid vehicle. A suitable soluble adhesive is that available from Philchem Corporation, Greer, S.C. as L1000 textile sizing.

The slurry may alternatively be applied by padding onto the surface 14S of the backing 14.

After application of the slurry the backing 14 is again heated, as indicated by block 30. In the heating device the surface of the backing 14 is heated to a temperature that is above the evaporation temperature of the vehicle, above the setting temperature of the soluble adhesive, and below the melting temperature of the powder binder. As a result a layer of binder supported in a matrix of adhesive is disposed over the surface of the backing. The layer is similar to the layer 24L′ shown in the diagrammatic view of FIG. 3B.

In accordance with this embodiment of the invention, after stitching the pile surface structure 10 is soaked, as indicated at reference character 39, to dissolve and remove the adhesive matrix. Scouring may also be performed with the soaking, if desired.

After soaking the pile surface structure 10 is flexed into and out of the plane of the backing, as discussed in connection with block 32 in FIG. 2A. The pile surface structure may thereafter be dried, as indicated by the block 38.

FIG. 2D diagrammatically indicates additional techniques by which the binder material may be initially applied in the vicinity of the root portion of the loops of the pile surface structure. For example, a strand 25 of binder material may be laid-in the pile surface structure with the pile yarn. The binder strand 25 may be supplied from a suitable beams or bobbins (shown diagrammatically at 74 in FIG. 2D).

As illustrated in FIG. 3D the binder strand 25 may be laid-in above the root portion 16R of the pile element 16 and is held in place by the thread underlaps 20U. Alternatively or additionally, the strand 25 of binder material may be laid-in with the pile yarn so that the binder strand 25 lies below the root portion 16R (FIG. 3E). Yet further, the binder strand 25 may be transversely inserted to lie beneath the root portions 16R of the pile elements using a weft-insertion apparatus. The resulting pile surface structure is illustrated in FIG. 3F.

The binder material may alternatively or additionally be introduced into the pile surface structure as part of a composite stitching thread 25T. In this case the composite thread 25T originates from a suitable beam or creel of bobbins (shown diagrammatically at 76 in FIG. 2D). The resulting pile structure is illustrated in FIG. 3G.

The remaining steps of the method diagrammatically illustrated in FIG. 2D may be implemented as described in connection with FIG. 2A.

FIGS. 2E illustrates yet another alternative manner in which the binder material may be initially applied to the pile surface structure. In this embodiment the pile surface structure is fabricated using a backing 14′ of a type an open structure adapted to permit a liquid slurry to penetrate therethrough.

After stitching 32 (and scouring 36, if desired) a slurry similar to that described in connection with FIG. 2A is applied to the bottom surface of the pile surface structure, as illustrated by the block 26. The liquid penetrates through the backing 14′ to reach the vicinity of the root portion 16R of the loops 16L. The resulting pile surface structure, wherein the liquid binder permeates the structure as indicated by the waved lines 24L³, is illustrated in FIG. 3H.

The resulting pile surface structure is thereafter flexed as indicated at the block 34 and optionally dried, as indicated at the block 38, both in the manner described earlier in connection with FIG. 2A.

Those skilled in the art, having the benefit of the teachings of the present invention, as hereinabove set forth, may effect numerous modifications thereto. It should be understood that all such modifications lie within the contemplation of the present invention as defined by the appended claims.

What is claimed is:

1. A process for bonding an array of pile loops stitched onto a surface of a backing, each pile loop having a root portion that is held to the surface of a backing by a stitching thread, the process comprising:
applying a thermoplastic binder material having a predetermined melting point in the vicinity of the root portion of the loops;
mechanically flexing the backing with the loops thereon into and out of the plane of the backing at a temperature greater than the melting point of the binder,
thereby to cause the binder material to melt and to flow into the root portion of the pile loops in the vicinity of the stitching thread underlaps.

2. The process of claim 1 wherein the thermoplastic binder material is applied to the surface of the backing.

3. The process of claim 1 wherein the temperature is maintained by immersing the backing with the pile loops thereon in a liquid having a temperature greater than the melting point of the binder.

4. The process of claim 3 further comprising the step: after immersion in the liquid, drying the backing.

5. The process of claim 4 wherein the backing is dried at a temperature of at least one hundred ten degrees Centigrade (110° C.) for at least 2 minutes.

6. The process of claim 1 wherein the temperature is maintained by passing steam over the backing with the pile loops thereon.

7. The process of claim 1 further comprising the step: after passing steam over the backing, drying the backing.

8. The process of claim 7 wherein the backing is dried at a temperature of at least one hundred ten degrees Centigrade (110° C.) for at least 2 minutes.

9. The process of claim 1 wherein the temperature is maintained by passing over the backing a heated gas having a temperature greater than the melting point of the binder.

10. The process of claim 1 further comprising the step: prior to mechanically flexing the backing, scouring the pile loops to remove substantially all oil and finish therefrom.

11. The process of claim 6 further comprising the step: prior to mechanically flexing the backing, scouring the pile loops to remove substantially all oil and finish therefrom.

12. The process of claim 9 further comprising the step: prior to mechanically flexing the backing, scouring the pile loops to remove substantially all oil and finish therefrom.

13. The process of claim 2 wherein the thermoplastic binder is an amorphous binder in the form of a powder having particle sizes in the range of one (1) to five hundred (500) microns, the powder binder having a melting point in the range from about eighty-five (85) to about one hundred degrees Centigrade (100° C.).

14. The process of claim 13 wherein the powder binder is applied to the backing in a dry state,
wherein the process further comprises the step of:
after application of the powder binder, heating the surface of the backing to a temperature greater than the melting point of the powder binder thereby to melt the powder binder to attach it to the surface of the backing.

15. The process of claim 13 wherein the powder binder is applied to the backing in a melt-blown dry state.

16. The process of claim 13 wherein the powder binder is applied to the backing in the form of a slurry comprising the binder powder dispersed in a liquid vehicle,
wherein the process further comprises the step of:
after application of the binder slurry, heating the surface of the backing to a temperature greater than the melting point of the powder binder thereby to melt the powder binder to attach the same to the surface of the backing.

17. The process of claim 13 wherein the powder binder is applied to the backing in the form of a slurry comprising the binder powder dispersed in a liquid vehicle, the liquid vehicle having a soluble adhesive dissolved therein,
the soluble adhesive having a setting point in the range from five (5) to twenty (20) degrees Centigrade ° C. below the melting point of the binder,
wherein the process further comprises the step of:
after application of the binder slurry, heating the surface of the backing to a temperature greater than the setting point of the soluble adhesive but below the melting point of the powder binder thereby to attach the powder binder to the surface of the backing.

18. The process of claim 17 wherein prior to mechanically flexing the backing the formed pile structure is soaked in water for at least one (1) minute.

19. The process of claim 13 wherein the thermoplastic binder powder is mixed with a secondary thermoplastic adhesive powder having particle sizes in the range of one (1) to five hundred (500) microns, the dry powder adhesive having a melting point in the range from five (5) to twenty (20) degrees Centigrade ° C. below the melting point of the binder.

20. The process of claim 19 wherein the mixture of powder binder and a secondary thermoplastic adhesive powder is applied to the backing in a dry state,
wherein the process further comprises the step of:
after application of the powder mixture, heating the surface of the backing to a temperature greater than the melting point of the secondary thermoplastic adhesive powder thereby to melt the a secondary thermoplastic adhesive powder to attach the powder binder to the surface of the backing.

21. The process of claim 19 wherein the mixture of powder binder and the secondary thermoplastic adhesive powder is applied to the backing in the form of a slurry comprising the binder powder and the secondary thermoplastic adhesive powder dispersed in a liquid vehicle,
wherein the process further comprises the step of:
after application of the slurry, heating the surface of the backing to a temperature greater than the melting point of the secondary thermoplastic adhesive powder thereby to melt the secondary thermoplastic adhesive powder to attach the binder powder to the surface of the backing.

22. The process of claim 2 wherein the binder is in the form of a strand of binder material that is laid into the vicinity of the root portions of the pile loops.

23. The process of claim 22 wherein the binder strand is disposed under the underlaps.

24. The process of claim 22 wherein the binder strand is disposed between the root portions of the pile elements and the backing.

25. The process of claim 22 wherein the stitching threads includes a binder material.

26. The process of claim 22 wherein the binder strand is weft-inserted between the root portions of the pile elements and the backing.

27. The process of claim 22 wherein the backing has an upper and a bottom surface thereon and an open structure adapted to permit a liquid slurry to penetrate therethrough, and wherein the binder material is applied in the form of a liquid slurry to the bottom surface of the backing.
